(19) United States
(12) Patent Application Publication
(10) Pub. No.: US 2023/0124203 A1
(43) Pub. Date: Apr. 20, 2023

(54) PLANT TRAINING PODS FOR AN INDOOR GARDENING APPLIANCE

(71) Applicant: Haier US Appliance Solutions, Inc., Wilmington, DE (US)

(72) Inventors: Louis A. Wantland, Louisville, KY (US); Brian Allgeier, Louisville, KY (US)

(21) Appl. No.: 17/501,233

(22) Filed: Oct. 14, 2021

(51) Int. Cl. A01G 31/06; A01G 29/00

(52) U.S. Cl. CPC A01G 31/06; A01G 29/00

(57) ABSTRACT

A gardening appliance includes a grow tower rotatably mounted within a liner, and defining a root chamber, a plurality of apertures defined through the grow tower for receiving plant pods, and a hydration system for periodically charging the root chamber with an aeroponic mist. A training pod is configured for receipt within at least one of the plurality of apertures and includes a frame defining a root containment chamber for receiving a root ball of hydroponic media, a media retention feature extending from the frame for engaging and securing the hydroponic media, and a water collection reservoir positioned adjacent the frame for collecting at least a portion of the aeroponic mist to hydrate the root ball of the hydroponic media.

### FIELD OF THE INVENTION

The present subject matter relates generally to systems for gardening plants indoors, and more particularly, to plant training pods for use within gardening appliances.

### BACKGROUND OF THE INVENTION

Conventional indoor garden centers include a cabinet defining a grow chamber having a number of trays or racks positioned therein to support seedlings or plant material, e.g., for growing herbs, vegetables, or other plants in an indoor environment. In addition, such indoor garden centers may include an environmental control system that maintains the growing chamber at a desired temperature or humidity. Certain indoor garden centers may also include hydration systems for watering the plants and/or artificial lighting systems that provide the light necessary for such plants to grow.

Certain indoor gardening appliances include a grow tower that includes features for supporting a plurality of plants. For example, conventional grow towers include openings for receiving plant pods that contains seeds or other plant material. Specifically, the plant pods are passed at least partially through the opening and into a root chamber. In an aeroponic system, the plant roots may be supplied with the hydration and nutrients necessary for growth by periodically misting water in the root chamber.

Certain conventional plant pods used in an aeroponic system are initially grown hydroponically, e.g., with roots submerged in a reservoir of water or otherwise periodically receiving a flow of water. However, roots formed in this manner are typically not capable of being directly transferred into an aeroponic system, e.g., where roots are periodically hydrated with mist. In this regard, hydroponic roots are typically “lazy” and are not able to absorb sufficient hydration from misting alone.

Accordingly, an improved indoor gardening appliance would be useful. More specifically, an indoor gardening appliance that hydrates using aeroponics but is capable of receiving hydroponically grown plant pods would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a gardening appliance defining a vertical direction is provided. The gardening appliance includes a liner positioned within a cabinet and defining a grow chamber, a grow tower rotatably mounted within the liner, the grow tower defining a root chamber, a plurality of apertures defined through the grow tower for receiving one or more plant pods that extend into the root chamber, a hydration system for periodically charging the root chamber with an aeroponic mist, and a training pod configured for receipt within at least one of the plurality of apertures. The training pod includes a frame defining a root containment chamber for receiving a root ball of hydroponic media, a media retention feature extending from the frame for engaging and securing the hydroponic media, and a water collection reservoir positioned adjacent the frame for collecting at least a portion of the aeroponic mist to hydrate the root ball of the hydroponic media.

In another exemplary embodiment, a training pod for a gardening appliance is provided. The gardening appliance includes a grow tower rotatably mounted within a liner and defining a root chamber, a plurality of apertures defined through the grow tower, and a hydration system for periodically charging the root chamber with an aeroponic mist. The training pod includes a frame defining a root containment chamber for receiving a root ball of hydroponic media, a media retention feature extending from the frame for engaging and securing the hydroponic media, and a water collection reservoir positioned adjacent the frame for collecting at least a portion of the aeroponic mist to hydrate the root ball of the hydroponic media.

According to still another embodiment, a method of training plants for growth in a gardening appliance is provided. The method includes placing hydroponically grown plant media in a training pod, the training pod comprising a frame defining a root containment chamber for receiving the hydroponically grown plant media, a media retention feature extending from the frame for engaging and securing the hydroponically grown plant media, and a water collection reservoir positioned adjacent the frame, inserting the training pod into an aperture of the grow tower, and operating a hydration system of the gardening appliance to charge the root chamber with an aeroponic mist such that at least a portion of the aeroponic mist is collected in the water collection reservoir

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a gardening appliance according to an exemplary embodiment of the present subject matter.

FIG. 2 depicts a front view of the exemplary gardening appliance of FIG. 1 with the doors open according to an exemplary embodiment of the present subject matter.

FIG. 3 is a cross sectional view of the exemplary gardening appliance of FIG. 1, taken along Line 3-3 from FIG. 2.

FIG. 4 is a top perspective view of the exemplary gardening appliance of FIG. 1, with a top panel and doors removed according to an exemplary embodiment of the present subject matter.

FIG. 5 is a perspective cross-sectional view of the exemplary gardening appliance of FIG. 1, taken along Line 5-5 from FIG. 2.

FIG. 6 is a top cross-sectional view of the exemplary gardening appliance of FIG. 1, taken along Line 5-5 from FIG. 2.

FIG. 7 provide a perspective view of a grow tower of the exemplary gardening appliance of FIG. 1 according to an exemplary embodiment of the present subject matter.

FIG. 8 provides a perspective view of a training pod that may be used within the exemplary gardening appliance of FIG. 1 according to an exemplary embodiment of the present subject matter.

FIG. 9 provides a perspective view of the exemplary training pod of FIG. 8 in an open position according to an exemplary embodiment of the present subject matter.

FIG. 10 provides a perspective view of the exemplary training pod of FIG. 8 with a water collection reservoir removed and hydroponically grown plant media according to an exemplary embodiment of the present subject matter.

FIG. 11 provides a perspective view of the exemplary training pod of FIG. 8 while the hydroponically grown plant media is being trained according to an exemplary embodiment of the present subject matter.

FIG. 12 provides a perspective view of the exemplary training pod of FIG. 8 after the hydroponically grown plant media has been trained according to an exemplary embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

Referring now to the figures, a gardening appliance 100 will be described in accordance with exemplary aspects of the present subject matter. According to exemplary embodiments, gardening appliance 100 may be used as an indoor garden center for growing plants. It should be appreciated that the embodiments described herein are intended only for explaining aspects of the present subject matter. Variations and modifications may be made to gardening appliance 100 while remaining within the scope of the present subject matter.

According to exemplary embodiments, gardening appliance 100 includes a cabinet 102 that is generally configured for containing and/or supporting various components of gardening appliance 100 and which may also define one or more internal chambers or compartments of gardening appliance 100. In this regard, as used herein, the terms “cabinet,” “housing,” and the like are generally intended to refer to an outer frame or support structure for gardening appliance 100, e.g., including any suitable number, type, and configuration of support structures formed from any suitable materials, such as a system of elongated support members, a plurality of interconnected panels, or some combination thereof. It should be appreciated that cabinet 102 does not necessarily require an enclosure and may simply include open structure supporting various elements of gardening appliance 100. By contrast, cabinet 102 may enclose some or all portions of an interior of cabinet 102. It should be appreciated that cabinet 102 may have any suitable size, shape, and configuration while remaining within the scope of the present subject matter.

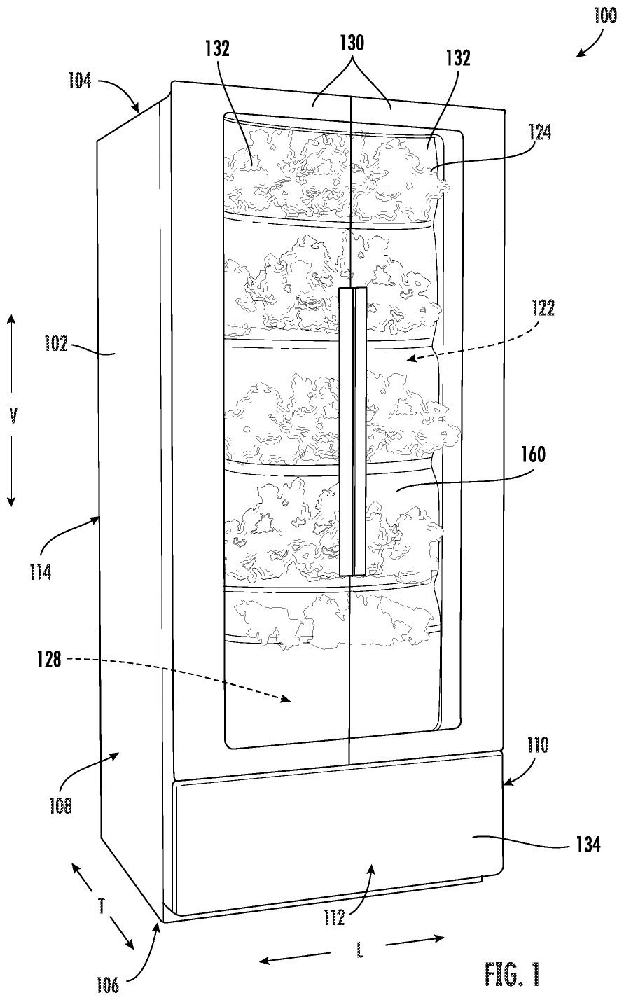

As illustrated, gardening appliance 100 generally defines a vertical direction V, a lateral direction L, and a transverse direction T, each of which is mutually perpendicular, such that an orthogonal coordinate system is generally defined. The horizontal direction is generally intended to refer to a direction perpendicular to the vertical direction V (e.g., within a plane defined by the lateral direction L and the transverse direction T). Cabinet 102 generally extends between a top 104 and a bottom 106 along the vertical direction V, between a first side 108 (e.g., the left side when viewed from the front as in FIG. 1) and a second side 110 (e.g., the right side when viewed from the front as in FIG. 1) along the lateral direction L, and between a front 112 and a rear 114 along the transverse direction T. In general, terms such as “left,” “right,” “front,” “rear,” “top,” or “bottom” are used with reference to the perspective of a user accessing gardening appliance 100.

Gardening appliance 100 may include an insulated liner 120 positioned within cabinet 102. Liner 120 may at least partially define an internal temperature-controlled chamber, referred to herein generally as a climate-controlled chamber 122, within which plants 124 may be grown. Although gardening appliance 100 is referred to herein as growing plants 124, it should be appreciated that other organisms or living things may be grown or stored in gardening appliance 100. For example, algae, fungi (e.g., including mushrooms), or other living organisms may be grown or stored in gardening appliance 100. The specific application described herein is not intended to limit the scope of the present subject matter in any manner.

Cabinet 102, or more specifically, liner 120 may define a substantially enclosed back portion 126 (e.g., proximate rear 114 of cabinet 102). In addition, cabinet 102 and liner 120 may define a front opening, referred to herein as front display opening 128 (e.g., proximate front 112 of cabinet 102), through which a user of gardening appliance 100 may access climate-controlled chamber 122, e.g., for harvesting, planting, pruning, or otherwise interacting with plants 124. According to an exemplary embodiment, enclosed back portion 126 may be defined as a portion of liner 120 that defines climate-controlled chamber 122 proximate rear side 114 of cabinet 102. In addition, front display opening 128 may generally be positioned proximate or coincide with front side 112 of cabinet 102.

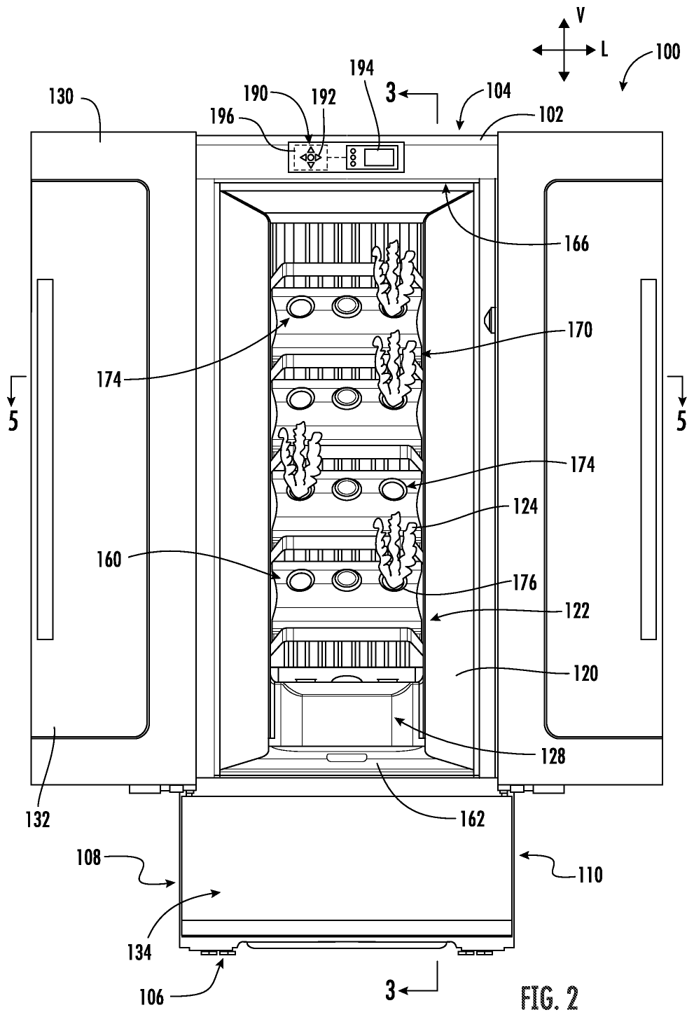

Gardening appliance 100 may further include one or more doors 130 that are rotatably mounted to cabinet 102 for providing selective access to climate-controlled chamber 122. For example, FIG. 1 illustrates doors 130 in the closed position such that they may help insulate climate-controlled chamber 122. By contrast, FIG. 2 illustrates doors 130 in the open positioned to permit access to climate-controlled chamber 122 and plants 124 stored therein. Doors 130 may further include a transparent window 132 through which a user may observe plants 124 without opening doors 130.

Although doors 130 are illustrated as being rectangular and being mounted on front side 112 of cabinet 102 in FIGS. 1 and 2, it should be appreciated that according to alternative embodiments, doors 130 may have different shapes, mounting locations, etc. For example, doors 130 may be curved, may be formed entirely from glass, etc. In addition, doors 130 may have integral features for controlling light passing into and/or out of climate-controlled chamber 122, such as internal louvers, tinting, UV treatments, polarization, etc. One skilled in the art will appreciate that other chamber and door configurations are possible and within the scope of the present subject matter.

According to the illustrated embodiment, cabinet 102 further defines a drawer 134 positioned proximate bottom 106 of cabinet 102 and being slidably mounted to cabinet 102 for providing convenient storage for plant nutrients, system accessories, water filters, etc. In addition, behind drawer 134 is a mechanical compartment 136 for receipt of an environmental control system including a sealed system for regulating the temperature within climate-controlled chamber 122, as described in more detail below.

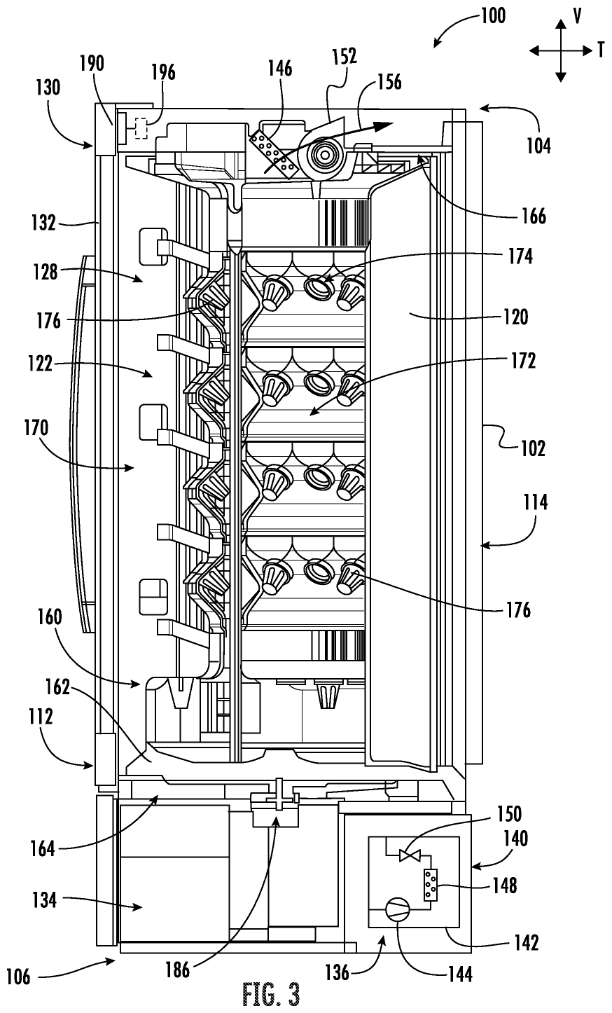

FIG. 3 provides a schematic view of certain components of an environmental control system 140 that may be used to regulate a climate or environment within climate-controlled chamber 122. Specifically, environmental control system 140 may include one or more subsystems for regulating temperature, humidity, hydration, nutrient dosing, lighting, and any other aspects of the environment within one or more portions of climate-controlled chamber 122, e.g., as desired to facilitate improved or regulated growth of plants 124 positioned therein. Although exemplary subsystems and subsystem configurations are described below, it should be appreciated that aspects of environmental control system 140 may vary while remaining within the scope of the present subject matter.

As illustrated, environmental control system 140 includes a sealed system 142 that is generally configured for regulating a temperature and/or humidity within one or more regions of climate-controlled chamber 122. In this regard, as shown schematically in FIG. 3, sealed system 142 may be located partially within mechanical compartment 136 and includes a compressor 144, a first heat exchanger or evaporator 146 and a second heat exchanger or condenser 148. As is generally understood, compressor 144 is generally operable to circulate or urge a flow of refrigerant through sealed system 142, which may include various conduits which may be utilized to flow refrigerant between the various components of sealed system 142. Thus, evaporator 146 and condenser 148 may be between and in fluid communication with each other and compressor 144.

During operation of sealed system 142, refrigerant flows from evaporator 146 and to compressor 144. For example, refrigerant may exit evaporator 146 as a fluid in the form of a superheated vapor. Upon exiting evaporator 146, the refrigerant may enter compressor 144, which is operable to compress the refrigerant and direct the compressed refrigerant to condenser 148. Accordingly, the pressure and temperature of the refrigerant may be increased in compressor 144 such that the refrigerant becomes a more superheated vapor.

Condenser 148 is disposed downstream of compressor 144 and is operable to reject heat from the refrigerant. For example, the superheated vapor from compressor 144 may enter condenser 148 and transfer energy to air surrounding condenser 148 (e.g., to create a flow of heated air). In this manner, the refrigerant condenses into a saturated liquid and/or liquid vapor mixture. A condenser fan (not shown) may be positioned adjacent condenser 148 and may facilitate or urge the flow of heated air across the coils of condenser 148 (e.g., from ambient atmosphere) in order to facilitate heat transfer.

According to the illustrated embodiment, an expansion device or a variable electronic expansion valve 150 may be further provided to regulate refrigerant expansion. During use, variable electronic expansion valve 150 may generally expand the refrigerant, lowering the pressure and temperature thereof. In this regard, refrigerant may exit condenser 148 in the form of high liquid quality/saturated liquid vapor mixture and travel through variable electronic expansion valve 150 before flowing through evaporator 146. Variable electronic expansion valve 150 is generally configured to be adjustable, e.g., such that the flow of refrigerant (e.g., volumetric flow rate in milliliters per second) through variable electronic expansion valve 150 may be selectively varied or adjusted.

Evaporator 146 is disposed downstream of variable electronic expansion valve 150 and is operable to heat refrigerant within evaporator 146, e.g., by absorbing thermal energy from air surrounding the evaporator (e.g., to create a flow of cooled air). For example, the liquid or liquid vapor mixture refrigerant from variable electronic expansion valve 150 may enter evaporator 146. Within evaporator 146, the refrigerant from variable electronic expansion valve 150 receives energy from the flow of cooled air and vaporizes into superheated vapor and/or high-quality vapor mixture. An air handler or evaporator fan 152 is positioned adjacent evaporator 146 and may facilitate or urge the flow of cooled air across evaporator 146 in order to facilitate heat transfer. From evaporator 146, refrigerant may return to compressor 144 and the vapor-compression cycle may continue.

As explained above, environmental control system 140 includes a sealed system 142 for providing a flow of heated air or a flow cooled air throughout climate-controlled chamber 122 as needed. To direct this air, environmental control system 140 may include a duct system 154 for directing the flow of temperature regulated air, identified herein simply as flow of air 156 (see, e.g., FIG. 3). In this regard, for example, evaporator fan 152 can generate a flow of cooled air as the air passes over evaporator 146 and a condenser fan (not shown) can generate a flow of heated air as the air passes over condenser 148.

This temperature-regulated flow of air 156 may be routed through a cooled air supply duct and/or heated air may be routed through a heated air supply duct (not shown). In this regard, it should be appreciated that environmental control system 140 may generally include a plurality of ducts, dampers, diverter assemblies, and/or air handlers to facilitate operation in a cooling mode, in a heating mode, in both a heating and cooling mode, or any other mode suitable for regulating the environment within climate-controlled chamber 122. It should be appreciated that duct system 154 may vary in complexity and may regulate the flows of air from sealed system 142 in any suitable arrangement through any suitable portion of climate-controlled chamber 122.

Although an exemplary sealed system 142 and duct system 154 are illustrated and described herein, it should be appreciated that variations and modifications may be made to sealed system 142 and/or duct system 154 while remaining within the scope of the present subject matter. For example, sealed system 142 may include additional or alternative components, duct system 154 may include additional or different ducting configurations, etc. For example, according to the illustrated embodiment, evaporator 146 and evaporator fan 152 may be positioned at top 104 of cabinet 102 and refrigerant may be routed from mechanical compartment 136 and through cabinet 102 to evaporator 146. In addition, it should be appreciated that gardening appliance 100 may have one or more subsystems integrated with or operably coupled to duct system 154 for filtering the flow of air 156, regulating the concentration of one or more gases within the flow of air 156, etc.

Referring now generally to FIGS. 1 through 7, gardening appliance 100 generally includes a rotatable carousel, referred to herein as a grow tower 160 that is mounted within liner 120, e.g., such that it is within climate-controlled chamber 122. More specifically, grow tower 160 may be positioned on top of a turntable 162 that is rotatably mounted to a sump 164 of gardening appliance 100. In general, grow tower 160 extends along the vertical direction V from sump 164 to a top wall 166 of climate-controlled chamber 122.

In addition, grow tower 160 is generally rotatable about a central axis 168 defined by turntable 162. Specifically, according to the illustrated embodiment, central axis 168 is parallel to the vertical direction V. However, it should be appreciated that central axis 168 could alternatively extend in any suitable direction, e.g., such as the horizontal direction (e.g., defined by the lateral direction L and the transverse direction T). In this regard, grow tower 160 generally defines an axial direction A, i.e., parallel to central axis 168, a radial direction R that extends perpendicular to central axis 168, and a circumferential direction C that extends around central axis 168 (e.g., in a plane perpendicular to central axis 168).

As illustrated, grow tower 160 may generally separate, divide, or partition climate-controlled chamber 122 into a plurality of grow chambers (e.g., identified generally by reference numeral 170). More specifically, grow chambers 170 are generally defined between grow tower 160 and liner 120 or between grow tower 160 and doors 130. In general, grow chambers 170 are intended to support the leafy growth of plants 124 (e.g., or other portions of plants 124 other than the plant roots). According to the illustrated embodiment, grow tower 160 divides climate control chamber 122 into three grow chambers 170, referred to herein generally as a first chamber, a second chamber, and a third chamber. As illustrated, these grow chambers 170 are circumferentially spaced relative to each other and define substantially separate and distinct growing environments. As such, each grow chamber 170 may receive plants 124 having different growth needs and the grow environment within each respective grow chamber 170 may be maintained as grow tower 160 is rotated within climate-controlled chamber 122.

In addition, according to the illustrated embodiment, grow tower 160 may generally define an internal chamber, referred to herein as a root chamber 172. In general, root chamber 172 may be substantially sealed relative to (or isolated from) grow chambers 170 and is configured for containing the roots of plants 124 throughout the growing process. As will be described in more detail below, grow tower 160 may generally define one or more apertures 174 that are defined through grow tower 160 to permit access between grow chambers 170 and root chamber 172. According to exemplary embodiments, these apertures 174 may be configured to receive plant pods 176 into root chamber 172.

Plant pods 176 generally contain seedlings, root balls, or other plant material for growing plants 124 positioned within a mesh or other support structure through which roots of plants 124 may grow within grow tower 160. A user may insert a portion of plant pod 176 (e.g., a seed end or root end) having the desired seeds through one of the plurality of apertures 174 into root chamber 172. A plant end (e.g., opposite the root end) of the plant pod 176 may remain within grow chamber 170 such that plants 124 may grow from grow tower 160 such that they are accessible by a user.

As will be explained below, water and other nutrients may be supplied to the root end of plant pods 176 within root chamber 172. For example, according to the illustrated embodiment, root chamber 172 may be operably coupled with sealed system 142 for facilitating suitable climate control within the root chamber 172, e.g., to achieve desirable growing conditions. Similarly, a hydration system may be configured to provide a flow of hydrating mist including water, nutrients, and other suitable constituents for providing the desirable growth environment for plants 124. According to exemplary embodiments, apertures 174 may be covered by a flat flapper seal or seal cap (not shown) to prevent hydrating mist from escaping root chamber 172 when no plant pod 176 is installed and to facilitate improved climate control within root chamber 172 and grow chambers 170.

Although grow tower 160 described and illustrated above includes a single root chamber 172, it should be appreciated that according to alternative exemplary embodiments, grow tower 160 may further include one or more internal dividers (not shown) that are positioned within root chamber 172 to divide root chamber 172 into a plurality of sub-chambers or root chambers. Each of these root chambers may be partially or substantially isolated from the other root chambers to facilitate independent climate control, hydration, gas regulation, etc. In addition, each of these root chambers may be in fluid communication with one of the plurality of grow chambers 170 through the plurality of apertures 174.

Notably, it may be desirable according to exemplary embodiments to form a fluid-tight seal between the grow tower 160 and liner 120. In this manner, as grow tower 160 rotates within climate-controlled chamber 122, grow chambers 170 may remain fluidly isolated from each other. Therefore, according to an exemplary embodiment, grow tower 160 may generally define a grow module diameter (e.g., defined by its substantially circular footprint formed in a horizontal plane). Similarly, enclosed back portion 126 of liner 120 may be substantially cylindrical and may define a liner diameter (not labeled). In order to prevent a significant amount of air from escaping between grow tower 160 and liner 120, and in order to fluidly isolate the various grow chambers 170, the liner diameter may be substantially equal to or slightly larger than the grow module diameter.

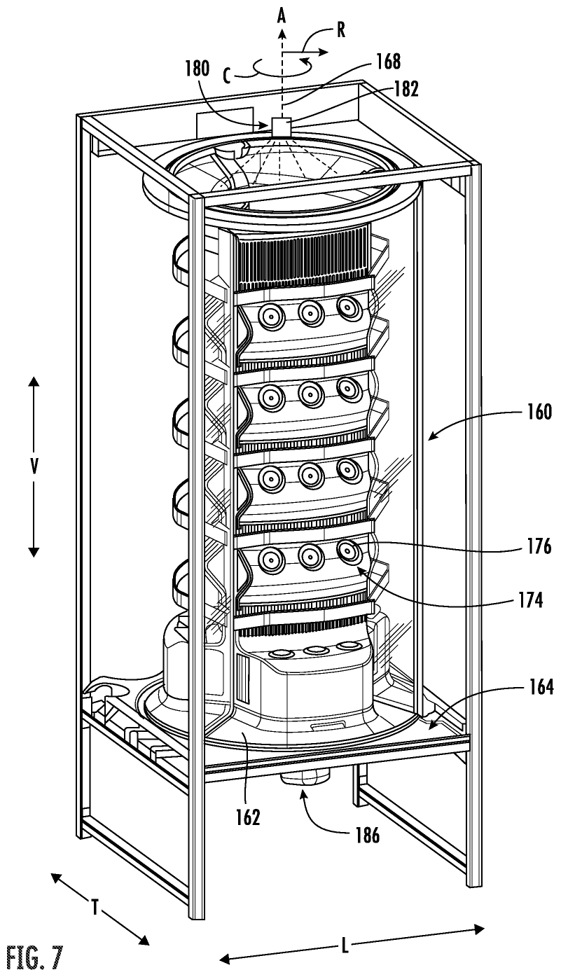

As best shown in FIG. 7, environmental control system 140 may further include a hydration system 180 which is generally configured for providing water and/or nutrients to plants 124 to support their growth. Specifically, according to the illustrated embodiment, hydration system 180 may be fluidly coupled to a water supply and or nutrient distribution assembly to selectively provide desirable quantities and concentrations of hydration, nutrients, and/or other fluids onto plants 124 to facilitate improved plant growth. For example, hydration system 180 includes misting device 182 (e.g., such as a fine mist spray nozzle or nozzles) that is fluidly coupled to a water supply (not shown). For example, the water supply may be a reservoir containing water (e.g., distilled water) or may be a direct connection municipal water supply. According to exemplary embodiments, hydration system 180 may include one or more pumps (not shown) for providing a flow of liquid nutrients to misting device 182. In this regard, for example, water or nutrients that are not absorbed by roots of plants 124 may fall under the force of gravity into sump 164 and these pumps may be fluidly coupled to sump 164 to recirculate the water through misting device 182.

According to the illustrated embodiment, misting device 182 is positioned at a top of root chamber 172 and may be configured for charging root chamber 172 with mist for hydrating the roots of plants 124. Alternatively, misting devices 182 may be positioned at a bottom of root chamber 172 (e.g., within sump 164) for spraying a mist or water into root chamber 172. Because various plants 124 may require different amounts of water for desired growth, hydration system 180 may alternatively include a plurality of misting devices 182, e.g., all coupled to the water supply and/or nutrient supplies. This plurality of misting devices 182 may be spaced apart at along the vertical direction V within root chamber 172. In this manner, these misting devices 182 may provide different concentrations of hydration and/or nutrients to different regions within root chamber 172.

Notably, environmental control system 140 described above is generally configured for regulating the temperature and humidity (e.g., or some other suitable water level quantity or measurement) within one or all of the plurality of chambers 170 and/or root chambers 172 independently of each other. In this manner, a versatile and desirable growing environment may be obtained for each and every chamber 170.

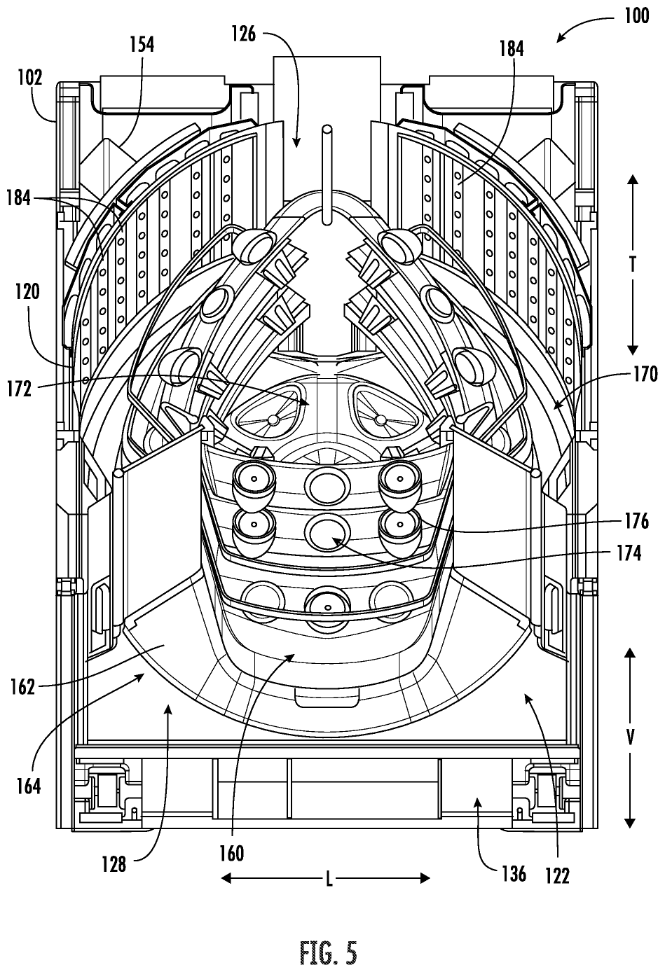

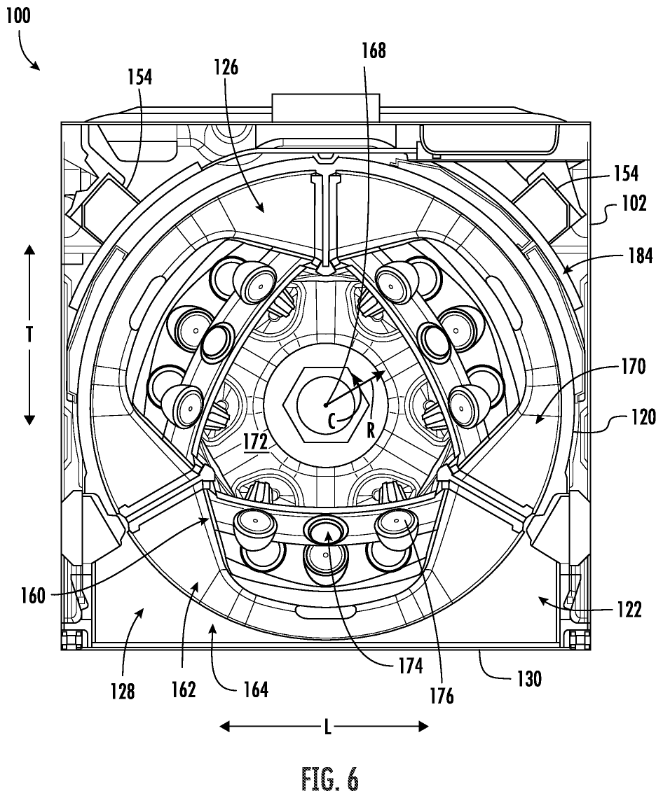

Referring now for example to FIGS. 5 and 6, gardening appliance 100 may further include a light assembly 184 which is generally configured for providing light into selected grow chambers 170 to facilitate photosynthesis and growth of plants 124. As shown, light assembly 184 may include a plurality of light sources (not labeled) stacked in an array, e.g., extending along the vertical direction V. For example, light assembly 184 may be mounted directly to liner 120 within climate-controlled chamber 122 or may alternatively be positioned behind liner 120 such that light is projected through a transparent window or light pipe into climate-controlled chamber 122. The position, configuration, and type of light sources described herein are not intended to limit the scope of the present subject matter in any manner.

Light assembly 184 may include any suitable number, type, position, and configuration of electrical light source(s), using any suitable light technology and illuminating in any suitable color. For example, according to the illustrated embodiment, light assembly 184 includes one or more light emitting diodes (LEDs), which may each illuminate in a single color (e.g., white LEDs), or which may each illuminate in multiple colors (e.g., multi-color or RGB LEDs) depending on the control signal from controller 196. However, it should be appreciated that according to alternative embodiments, light assembly 184 may include any other suitable traditional light bulbs or sources, such as halogen bulbs, fluorescent bulbs, incandescent bulbs, glow bars, a fiber light source, etc.

As explained above, light generated from light assembly 184 may result in light pollution within a room where gardening appliance 100 is located. Therefore, aspects of the present subject matter are directed to features for reducing light pollution, or to the blocking of light from light assembly 184 through front display opening 128. Specifically, as illustrated, light assembly 184 is positioned only within the enclosed back portion 126 of liner 120 such that only grow chambers 170 which are in a sealed position are exposed to light from light assembly 184. Specifically, grow tower 160 acts as a physical partition between light assemblies 184 and front display opening 128. In this manner, as illustrated in FIG. 5, no light may pass from the first or second grow chambers 170 (i.e., the “rear” or enclosed grow chambers 170) through grow tower 160 and out through front display opening 128. As grow tower 160 rotates, two of the three grow chambers 170 will receive light from light assembly 184 at a time. According to still other embodiments, a single light assembly may be used to reduce costs, whereby only a single grow chamber 170 will be illuminated at a single time.

Referring now specifically to FIGS. 3 and 7, gardening appliance 100 may further include a motor assembly 186 or another suitable driving element or device for selectively rotating grow tower 160 during operation of gardening appliance 100. In this regard, according to the illustrated embodiment, motor assembly 186 is positioned below grow tower 160, e.g., within mechanical compartment 136, and may be mechanically coupled to turntable 162 for selectively rotating turntable 162 and grow tower 160 about central axis 168.

As used herein, “motor” may refer to any suitable drive motor and/or transmission assembly for rotating turntable 162 and grow tower 160. For example, motor assembly 186 may include a brushless DC electric motor, a stepper motor, or any other suitable type or configuration of motor. For example, motor assembly 186 may include an AC motor, an induction motor, a permanent magnet synchronous motor, or any other suitable type of AC motor. In addition, motor assembly 186 may include any suitable transmission assemblies, clutch mechanisms, or other components.

Referring again to FIG. 2, gardening appliance 100 may include a control panel 190 that may represent a general-purpose Input/Output (“GPIO”) device or functional block for gardening appliance 100. In some embodiments, control panel 190 may include or be in operative communication with one or more user input devices 192, such as one or more of a variety of digital, analog, electrical, mechanical, or electro-mechanical input devices including rotary dials, control knobs, push buttons, toggle switches, selector switches, and touch pads.

Additionally, gardening appliance 100 may include a display 194, such as a digital or analog display device generally configured to provide visual feedback regarding the operation of gardening appliance 100. For example, display 194 may be provided on control panel 190 and may include one or more status lights, screens, or visible indicators. According to exemplary embodiments, user input devices 192 and display 194 may be integrated into a single device, e.g., including one or more of a touchscreen interface, a capacitive touch panel, a liquid crystal display (LCD), a plasma display panel (PDP), a cathode ray tube (CRT) display, or other informational or interactive displays.

Gardening appliance 100 may further include or be in operative communication with a processing device or a controller 196 that may be generally configured to facilitate appliance operation. In this regard, control panel 190, user input devices 192, and display 194 may be in communication with controller 196 such that controller 196 may receive control inputs from user input devices 192, may display information using display 194, and may otherwise regulate operation of gardening appliance 100. For example, signals generated by controller 196 may operate gardening appliance 100, including any or all system components, subsystems, or interconnected devices, in response to the position of user input devices 192 and other control commands. Control panel 190 and other components of gardening appliance 100 may be in communication with controller 196 via, for example, one or more signal lines or shared communication busses. In this manner, Input/Output (“I/O”) signals may be routed between controller 196 and various operational components of gardening appliance 100.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 196 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 196 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 196 may be operable to execute programming instructions or micro-control code associated with an operating cycle of gardening appliance 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 196 as disclosed herein is capable of and may be operable to perform any methods, method steps, or portions of methods as disclosed herein. For example, in some embodiments, methods disclosed herein may be embodied in programming instructions stored in the memory and executed by controller 196.

The memory devices may also store data that can be retrieved, manipulated, created, or stored by the one or more processors or portions of controller 196. The data can include, for instance, data to facilitate performance of methods described herein. The data can be stored locally (e.g., on controller 196) in one or more databases and/or may be split up so that the data is stored in multiple locations. In addition, or alternatively, the one or more database(s) can be connected to controller 196 through any suitable network(s), such as through a high bandwidth local area network (LAN) or wide area network (WAN). In this regard, for example, controller 196 may further include a communication module or interface that may be used to communicate with one or more other component(s) of gardening appliance 100, controller 196, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

According to an exemplary embodiment, motor assembly 186 may be operably coupled to controller 196, which is programmed to rotate grow tower 160 according to predetermined operating cycles, based on user inputs (e.g., via touch buttons 192), etc. In addition, controller 196 may be communicatively coupled to one or more sensors, such as temperature or humidity sensors, positioned within the various chambers 170 for measuring temperatures and/or humidity, respectively. Controller 196 may then operate motor assembly 186 in order to maintain desired environmental conditions for each of the respective chambers 170. For example, as described herein, gardening appliance 100 includes features or subsystems for providing certain locations of gardening appliance 100 with light, temperature control, proper moisture, nutrients, and other requirements for suitable plant growth. Motor assembly 186 may be used to position specific chambers 170 where needed to receive such growth requirements.

According to an exemplary embodiment, such as where grow tower 160 divides climate-controlled chamber 122 into three grow chambers 170, controller 196 may operate motor assembly 186 to index grow tower 160 sequentially through a number of preselected positions. More specifically, motor assembly 186 may rotate grow tower 160 in a counterclockwise direction (e.g., when viewed from a top of grow tower 160) in 120° increments to move chambers 170 between sealed positions and display positions. As used herein, a chamber 170 is considered to be in a “sealed position” when that chamber 170 is substantially sealed between grow tower 160 and liner 120. By contrast, a chamber 170 is considered to be in a “display position” when that chamber 170 is at least partially exposed to front display opening 128, such that a user may access plants 124 positioned within that chamber 170.

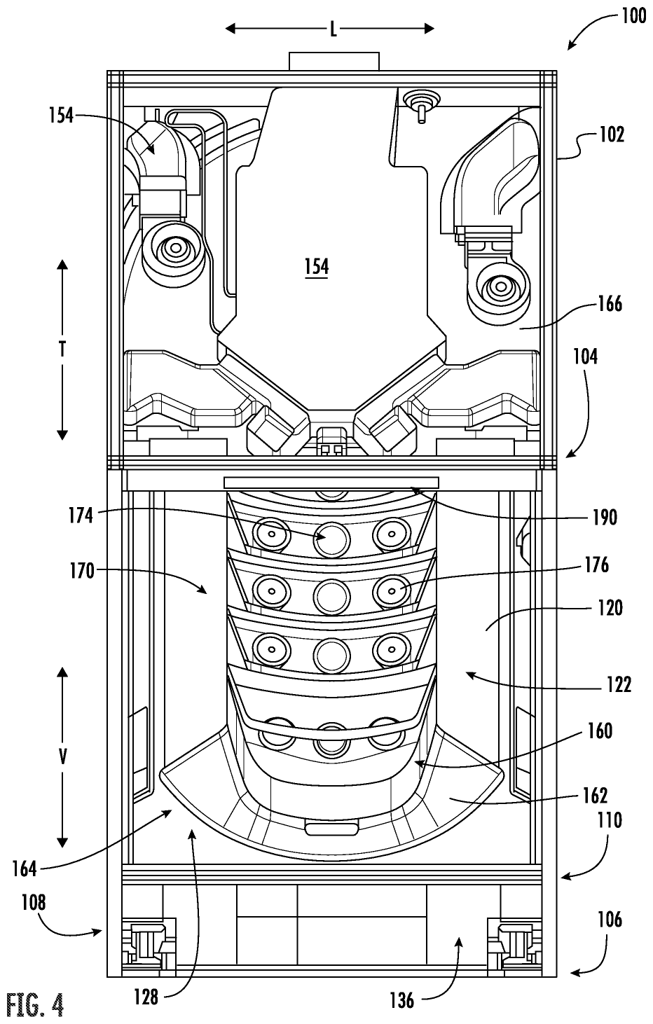

For example, as illustrated in FIGS. 4 and 5, the first grow chamber and the second grow chamber (i.e., the rear chambers) are both in a sealed position, whereas the third grow chamber (i.e., the front chamber) is in a display position. As motor assembly 186 rotates grow tower 160 by 120 degrees in the counterclockwise direction, the second grow chamber will enter the display position, while the first grow chamber and the third grow chamber will be in the sealed positions. Motor assembly 186 may continue to rotate grow tower 160 in such increments to cycle grow chambers 170 between these sealed and display positions.

Gardening appliance 100 and grow tower 160 have been described above to explain an exemplary embodiment of the present subject matter. However, it should be appreciated that variations and modifications may be made while remaining within the scope of the present subject matter. For example, according to alternative embodiments, gardening appliance 100 may be a simplified to a two-chamber embodiment with a square liner 120 and a grow tower 160 that divides the climate-controlled chamber 122 in half to define a first grow chamber and a second grow chamber. According to such an embodiment, by rotating grow tower 160 by 180 degrees about central axis 168, the first chamber may alternate between the sealed position (e.g., facing rear side 114 of cabinet 102) and the display position (e.g., facing front side 112 of cabinet 102). By contrast, the same rotation will move the second chamber from the display position to the sealed position.

According to still other embodiments, gardening appliance 100 may include a three chamber grow tower 160 but may have a modified cabinet 102 such that front display opening 128 is wider and two of the three grow chambers 170 are displayed at a single time. Thus, the first grow chamber may be in the sealed position, while the second grow chamber and the third grow chamber may be in the display positions. As grow tower 160 is rotated counterclockwise, the first grow chamber is moved into the display position and the third grow chamber is moved into the sealed position.

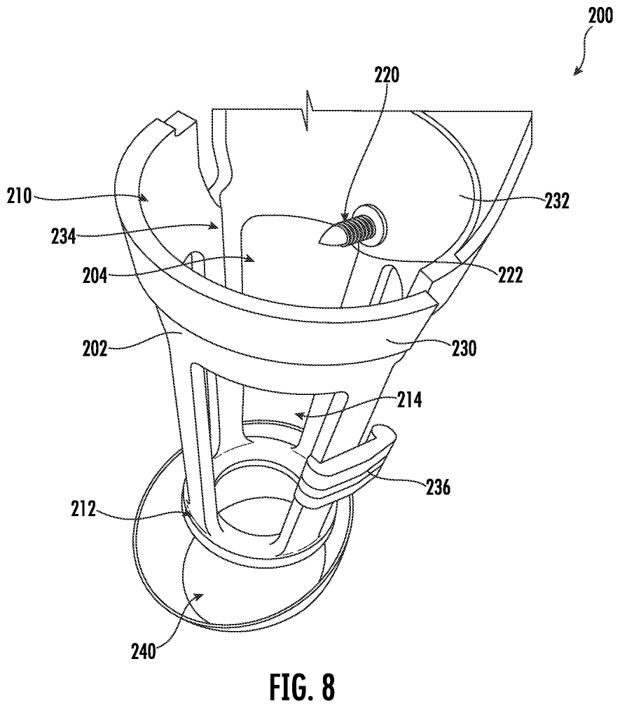

Referring now to generally to FIGS. 8 through 12, a training pod 200 will be described in more detail according to an exemplary embodiment of the present subject matter. Although an exemplary embodiment of training pod 200 is described herein, it should be appreciated that variations and modifications may be made to training pod 200 while remaining within the scope of the present subject matter. In addition, it should be appreciated that training pod 200 is not limited to the exemplary application described herein. Indeed, training pod 200 may be used within any gardening appliance.

In general, training pods 200 may be configured for receipt within apertures 174 of grow tower 160. For example, training pods 200 may be similar to plant pods 176 and may have many of the same or similar features. However, as will be described in more detail below, training pods 200 may include additional features that are generally intended to facilitate the training and/or growth of plants 124 from a hydroponic environment to an aeroponic environment. In this regard, hydration system 100 may generally be configured for periodically charging root chamber 172 with an aeroponic mist. Notably, as explained above, plants that are commonly used in gardening appliance 100 may be seeded or otherwise begin formation in a hydroponic system, e.g., a system where the roots of the plants are submerged or generally exposed to a flow of water. Aspects of the present subject matter are directed to training hydroponically grown plants in an aeroponics system to facilitate root adaptation and plant growth.

As shown, training pod 200 includes a frame 202 that generally defines a root containment chamber 204. In general, root containment chamber 204 is a cavity defined within frame 202 within which a root ball 206 of hydroponic media 208 may be positioned. In general, root ball 206 is intended to refer to the roots of hydroponically grown plants while hydroponic media 208 is a general term intended to refer to any plant material initially grown in a hydroponic environment. According to the illustrated embodiment, frame 202 defines a front opening 210 through which plants 124 may be inserted into root containment chamber 204. Frame 202 may further be tapered away from the front opening 210 toward a root end 212 of frame 202. In this regard, the diameter of frame 202 at front opening 210 may be larger than the diameter of frame 202 at root end 212. In this manner, training pod 200 may be easy to insert through aperture 174 and may have a tendency to support hydroponic media 208 and prevent it from sliding directly through frame 202.

In addition, according to the illustrated embodiment, frame 202 may define a plurality of voids 214 proximate root end 212 through which root ball 206 of hydroponic media 208 may grow and transition into aeroponic roots (e.g., as identified generally by reference numeral 216 in FIG. 12). In general, aeroponic roots 216 are generally more capable of absorbing water and nutrients from aeroponic mist generated by hydration system 180, particularly relative to lazy hydroponically formed roots. In this regard, for example, aeroponic roots 216 may include finer roots or root extensions that extend outward to form a fluffy root ball that covers a large volume. By contrast, as best shown in FIG. 10, the root ball 206 of hydroponically formed plants before being trained are typically consolidated and compacted, e.g., due to the relative ease of absorbing nutrients while sitting within a pool or reservoir of water.

As best shown in FIGS. 8, 9, and 12, training pod 200 may further include a media retention feature 220 that extends from frame 202 for engaging and securing the hydroponic media 208. In this regard, for example, media retention feature 220 may include a protrusion, a spike, a barb, or any other mechanical feature for engaging the root ball 206 of hydroponic media 208, e.g., to secure hydroponic media 208 within root containment chamber 204 so that it does not fall out or move during plant growth. For example, according to the illustrated embodiment, media retention feature 220 may be a small mechanical screw 222 that extend inward along the radial direction toward a center of root containment chamber 204. Notably, this mechanical screw 222 may be particularly suited to engage the fibrous, mesh-like, or interwoven structure of root ball 206 of hydroponic media 208. It should be appreciated that other suitable retention features are possible and within the scope of the present subject matter.

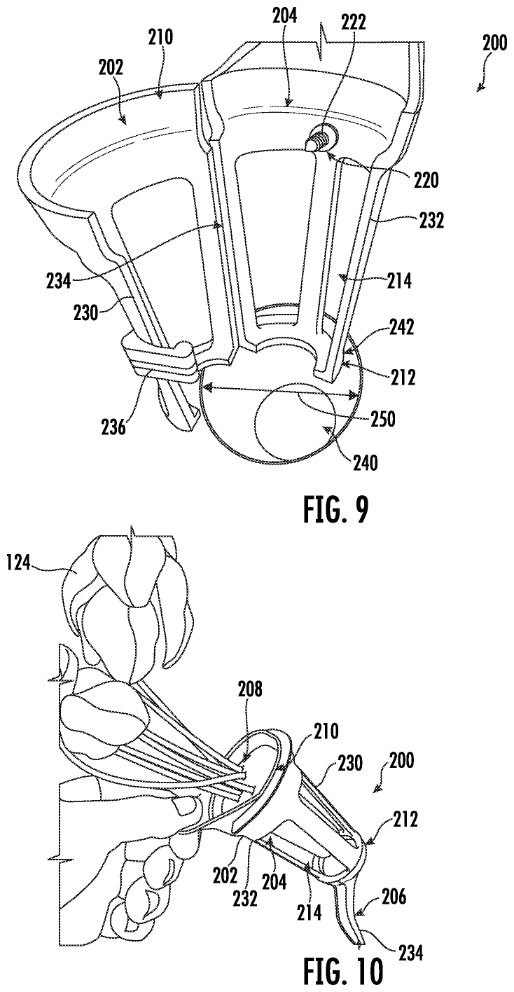

Training pod 200 may further include features that simplify the installation of hydroponic media 208 within frame 202. In this regard, for example, frame 202 may include a first half 230 and a second half 232 that are pivotally joined ata hinge 234. In this manner, first half 230 and second half 232 may be pivoted between an open position (e.g., as shown in FIG. 9) and a closed position (e.g., as shown in FIG. 8) to facilitate media introduction into frame 202. After hydroponic media 208 has been installed and first half 230 and second half 232 have been pivoted to the closed position, latch 236 of frame 202 may be used secure first half 230 and second half 232 together to prevent removal of hydroponic media 208.

Notably, as explained above, when a hydroponic media 208 is first installed in an aeroponics system, e.g., such as gardening appliance 100 which relies on aeroponic mist from hydration system 180 for hydration and nutrients, the root ball 206 of such hydroponic media 208 may not be capable of properly absorbing hydration. In this regard, the lazy roots (e.g., see FIG. 10) may not absorb the fine mist charge within root chamber 172. Accordingly, this hydroponic media 208 may quickly wither and die. Accordingly, aspects of the present subject matter are directed to features for providing such nutrients until proper aeroponic roots have been formed.

In this regard, as best shown in FIGS. 8, 9, 11, and 12, training pod 200 may include a water collection reservoir 240 that is positioned adjacent frame 202 or is otherwise extending from frame 202 for collecting at least a portion of the aeroponic mist to hydrate the root ball 204 of the newly introduced hydroponic media 208. In this regard, water collection reservoir 240 may be a small cup that is positioned below or adjacent root end 212 of frame 202 such that positioning hydroponic media 208 within frame 202 results in root ball 206 being seated at least partially within water collection reservoir 240. When hydration system 180 charges root chamber 172 with the aeroponic mist, at least a portion of such mist is collected within water collection reservoir 240 to hydrate and provide nutrients to root ball 206.

In this manner, water collection reservoir 240 may generally hydrate hydroponic media 208 until proper aeroponic roots 216 are formed. Notably, according to an exemplary embodiment, water collection reservoir 240 may be removed from frame 202 after such aeroponic roots 216 are formed. In this manner, for example, water collection reservoir 240 may be connected to frame 202 through a perforated or frangible bridge 242 such that water collection reservoir 240 may be simply snapped off or broken away from frame 202. According to still other embodiments, water collection reservoir 240 may be a permanent structure of frame 202.

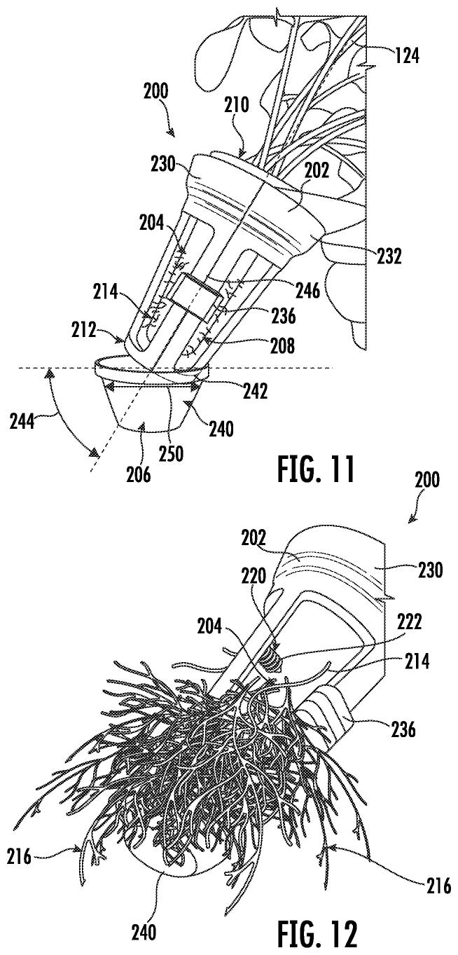

As best shown in FIG. 11, water collection reservoir 240 may be supported at an angle 244 relative to a central frame axis 246. In this manner, for example, angle 244 may be selected such that water collection reservoir 240 is supported in a horizontal orientation when training pod 200 is installed within grow tower 160. In this manner, water collection reservoir 240 may be small but capable of collecting sufficient water to hydrate hydroponic media 208. In addition, water collection reservoir 240 may be sized such that it is easy to insert through apertures 174 of grow tower 160. In this regard, for example, a width 250 of water collection reservoir 240 (e.g., measured within a horizontal plane) may be less than the diameter of frame 202, e.g., such as a diameter of front opening 210.

It should be appreciated that various features of training pod 200 may be formed from any suitably rigid material. For example, according to exemplary embodiments, frame 202 and water collection reservoir 240 may be formed by injection molding, e.g., using a suitable plastic material, such as injection molding grade Polybutylene Terephthalate (PBT), Nylon 6, high impact polystyrene (HIPS), acrylonitrile butadiene styrene (ABS), or any other suitable blend of polymers. Alternatively, according to the exemplary embodiment, these components may be compression molded, e.g., using sheet molding compound (SMC) thermoset plastic or other thermoplastics. According to still other embodiments, portions of training pod 200 may be formed from any other suitable rigid material.

Aspects of the present subject matter may further be directed to a method for training plants for growth within a gardening appliance. More specifically, the method may be intended to transition hydroponically grown media into aeroponic media. In this regard, for example, the method may include placing hydroponically grown plant media in a training pod (e.g., such as training pod 200). The training pod may include a frame defining a root containment chamber for receiving the hydroponically grown plant media, a media retention feature extending from the frame for engaging and securing the hydroponically grown plant media, and a water collection reservoir positioned adjacent the frame.

According to an exemplary embodiment, placing hydroponically grown plant media in the training pod may include opening the frame by separating a first half of the frame from a second half, inserting the hydroponically grown plant media into the root containment chamber such that it is secured by the media retention feature, and closing and latching the training pod using a latch of the frame. The method may further include inserting the training pod into an aperture of the grow tower and operating a hydration system of the gardening appliance to charge the root chamber with an aeroponic mist such that at least a portion of the aeroponic mist is collected in the water collection reservoir. In this manner, roots of a hydroponically formed plant may be seated within the water collection reservoir to hydrate the plant until proper aeroponic roots performed. After such aeroponic roots are formed, the hydroponically grown plant may survive in the aeroponic environment, with or without the water collection reservoir.

Aspects of the present subject matter are generally directed to a special plant training pod that can be used to receive a root ball, seedling, or other plant media or material that was hydroponically grown. This plant training pod may then be positioned within an aeroponic gardening system such that it is periodically hydrated with mist such that the plant survives while the roots are slowly trained to absorb the aeroponic water and nutrients. In this regard, the plant material would transition from growth in one environment (e.g., a hydroponic environment) to the aeroponic environment. Thus, the “lazy” hydroponic roots that are used to absorbing nutrients by being submerged in or surrounded by water, develop fine hairs or the ability to uptake nutrients in an aeroponic system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A gardening appliance defining a vertical direction, the gardening appliance, comprising:
a liner positioned within a cabinet and defining a grow chamber;
a grow tower rotatably mounted within the liner, the grow tower defining a root chamber;
a plurality of apertures defined through the grow tower for receiving one or more plant pods that extend into the root chamber;
a hydration system for periodically charging the root chamber with an aeroponic mist; and
a training pod configured for receipt within at least one of the plurality of apertures, the training pod comprising:
a frame defining a root containment chamber for receiving a root ball of hydroponic media;
a media retention feature extending from the frame for engaging and securing the hydroponic media; and
a water collection reservoir positioned adjacent the frame for collecting at least a portion of the aeroponic mist to hydrate the root ball of the hydroponic media.

2. The gardening appliance of claim 1, wherein the media retention feature comprises a protrusion, a spike, or a barb that extends into the root containment chamber.

3. The gardening appliance of claim 1, wherein a root end of the frame defines voids for permitting aeroponic roots to grow into the root chamber.

4. The gardening appliance of claim 1, wherein the frame comprises a first half and a second half pivotally joined at a hinge and a latch for securing the first half and the second half in a closed position.

5. The gardening appliance of claim 1, wherein the water collection reservoir is removable from the frame.

6. The gardening appliance of claim 1, wherein the water collection reservoir is supported at an angle relative to a central frame axis.

7. The gardening appliance of claim 1, wherein the water collection reservoir is supported in a horizontal orientation for collecting the aeroponic mist.

8. The gardening appliance of claim 1, wherein a width of the water collection reservoir is less than a diameter of the frame.

9. The gardening appliance of claim 1, wherein the frame is injection molded plastic from a polymer material.

10. A training pod for a gardening appliance, the gardening appliance comprising a grow tower rotatably mounted within a liner and defining a root chamber, a plurality of apertures defined through the grow tower, and a hydration system for periodically charging the root chamber with an aeroponic mist, the training pod comprising:
a frame defining a root containment chamber for receiving a root ball of hydroponic media;
a media retention feature extending from the frame for engaging and securing the hydroponic media; and
a water collection reservoir positioned adjacent the frame for collecting at least a portion of the aeroponic mist to hydrate the root ball of the hydroponic media.

11. The training pod of claim 10, wherein the media retention feature comprises a protrusion, a spike, or a barb that extends into the root containment chamber.

12. The training pod of claim 10, wherein a root end of the frame defines voids for permitting aeroponic roots to grow into the root chamber.

13. The training pod of claim 10, wherein the frame comprises a first half and a second half pivotally joined at a hinge and a latch for securing the first half and the second half in a closed position.

14. The training pod of claim 10, wherein the water collection reservoir is removable from the frame.

15. The training pod of claim 10, wherein the water collection reservoir is supported at an angle relative to a central frame axis.

16. The training pod of claim 10, wherein the water collection reservoir is supported in a horizontal orientation for collecting the aeroponic mist.

17. The training pod of claim 10, wherein a width of the water collection reservoir is less than a diameter of the frame.

18. The training pod of claim 10, wherein the frame is injection molded plastic from a polymer material.

19. A method of training plants for growth in a gardening appliance, the method comprising:
placing hydroponically grown plant media in a training pod, the training pod comprising a frame defining a root containment chamber for receiving the hydroponically grown plant media, a media retention feature extending from the frame for engaging and securing the hydroponically grown plant media, and a water collection reservoir positioned adjacent the frame;
inserting the training pod into an aperture of the grow tower; and
operating a hydration system of the gardening appliance to charge the root chamber with an aeroponic mist such that at least a portion of the aeroponic mist is collected in the water collection reservoir.

20. The method of claim 19, wherein the frame comprises a first half and a second half pivotally joined at a hinge and a latch for securing the first half and the second half in a closed position, and wherein placing the hydroponically grown plant media in the training pod comprises:
opening the frame by separating the first half from the second half;
inserting the hydroponically grown plant media into the root containment chamber such that it is secured by the media retention feature; and
closing and latching the training pod using the latch.
